(19) United States
(12) Patent Application Publication
(10) Pub. No.: US 2014/0322676 A1
(43) Pub. Date: Oct. 30, 2014

(54) METHOD AND SYSTEM FOR PROVIDING DRIVING QUALITY FEEDBACK AND AUTOMOTIVE SUPPORT

(71) Applicant: VERIZON PATENT AND LICENSING INC., Basking Ridge, NJ (US)

(72) Inventor: Madhusudan Raman, Sherborn, MA (US)

(73) Assignee: Verizon Patent and Licensing Inc., Basking Ridge, NJ (US)

(21) Appl. No.: 13/871,585

(22) Filed: Apr. 26, 2013

(51) Int. Cl. G09B 19/16

(52) U.S. Cl. CPC G09B 19/167
USPC 434/65

(57) ABSTRACT

An approach for determining and scoring driving quality in real-time while supporting various in-vehicle services and leveraging information associated with and related to the driving experience includes collecting, in real-time, a plurality of contextual parameters associated with a user, classifying driving behavior of the user based on the contextual parameters, wherein the driving behavior corresponds to operation of one or more vehicles by the user, and generating a driving profile for the user according to the classification.

### BACKGROUND INFORMATION

An emerging automotive trend related to service providers, smart phone device manufactures, and automobile manufactures, appearing particularly in high-end automotive segments, is the integration of smart phones and similar devices within automobiles. Adding to the complexity of the integration is the varying types (e.g., brands, interfaces, etc.) of smart phones and similar devices and the challenges of providing an integration experience that delivers an easy-to-use interface without increasing driver distraction across a wide range of both smart phones and automobiles. Related to this trend is the ability to acquire and leverage information regarding a user's driving ability with respect to services within the automotive industry, as well as other industries, through and/or in conjunction with the integration. As such, service providers, device manufacturers and automobile manufacturers face significant technical challenges to provide a reconfigurable service that integrates portable communication devices within the driving experience.

Based on the foregoing, there is a need for an approach for determining and scoring driving quality in real-time while supporting various in-vehicle services and leveraging information with respect to a driving experience as well as automotive support.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of determining and scoring driving quality in real-time while supporting various in-vehicle services and leveraging information associated with and related to the driving experience, according to one embodiment;

FIG. 2 is a diagram of an automotive support platform used in the system of FIG. 1, according to one embodiment;

FIG. 3 is a flowchart of a process for determining driver information based on multiple variables in order to determine a driving profile, according to one embodiment;

FIG. 4 is a flowchart of a process for categorizing driving scores onto a ratings grid, according to one embodiment;

FIG. 5 is a flowchart of a process for utilizing a predictive model to determine incentives based on a driver's driving score and/or driving profile, according to one embodiment;

FIG. 6 is a flowchart of a process for enabling an in-vehicle user identification, associated in-vehicle authenticated payment system and identifying the waking and/or emotional state of the driver, according to one embodiment;

FIG. 7 is a diagram of an automotive support platform utilized over a cloud network, according to one embodiment;

FIG. 8 is a diagram of a user interface associated with settings available to the driver utilized in the processes of FIGS. 3-6, according to one embodiment;

FIG. 9 is a diagram of a user interface of a report and breakdown of a driving score utilized in the processes of FIGS. 3-6, according to one embodiment;

FIG. 10 is a diagram of a user interface associated with the ability to dispatch offers to mobile users utilized in the processes of FIGS. 3-6, according to one embodiment;

FIG. 11 is a diagram of an incentives-determinative ratings grid utilized in the processes of FIGS. 5-6, according to one embodiment;

FIG. 12 is a diagram of a computer system that can be used to implement various exemplary embodiments; and

FIG. 13 is a diagram of a chip set that can be used to implement various exemplary embodiments.

### DESCRIPTION OF THE PREFERRED EMBODIMENT

An apparatus, method, and software for determining and scoring driving quality in real-time, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

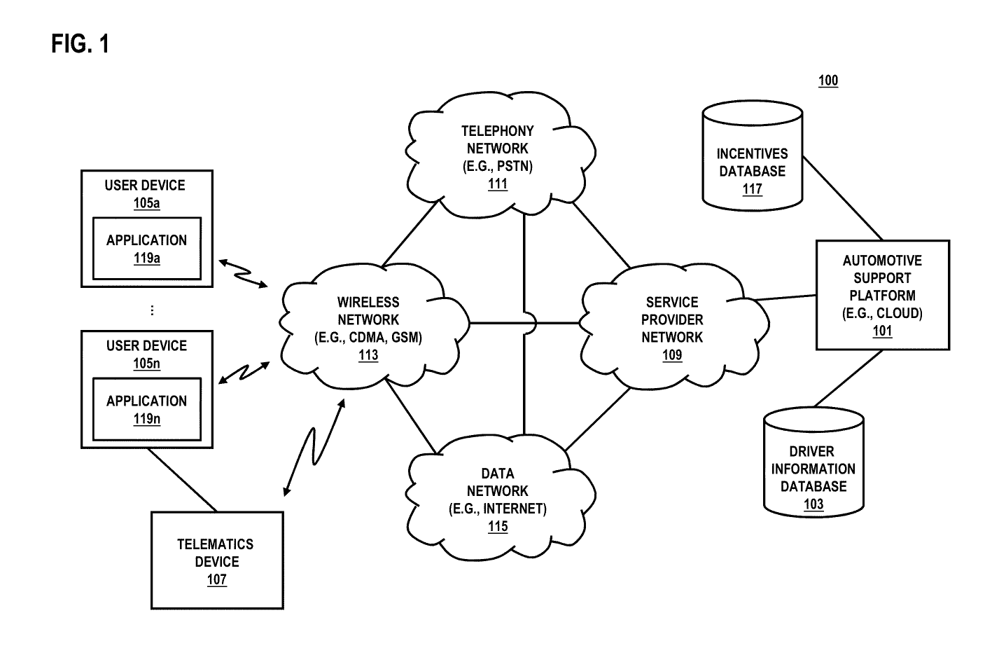

FIG. 1 is a diagram of a system capable of determining and scoring driving quality, in real-time, while supporting various in-vehicle services and leveraging unique aspects of location-based applications and information associated with and related to the driving experience, according to one embodiment. Integrated smart phone support for automotive services has only begun to adapt car ownership to mirror the smart phone experience. For example, integrated smart phone support for automotive services is only available in expensive, high-end vehicles, and thus inaccessible to a large part of the population. Additionally, integrated smart phone support for automotive services typically lacks flexibility such as integrating multiple smart phones or support for more than one smart phone brand or model.

To address these deficiencies, system 100 of FIG. 1 introduces an in-vehicle mobile user device integration service which identifies driving quality information of a user (e.g., driver). System 100 may continuously update a driver of her driving in the form of a live and dynamic driving score with the use of devices impacted by the driver's real time behavior. System 100 may span more than one contextual parameter (e.g., credit score, driving history, etc.). The driving score includes risks associated with the driving behavior and a predictive element (based, at least in part, on the collected driving behavior). Thus, this driving score may be a tool that incentivizes users towards safer driving practices. By way of example, as a social incentive, a favorable driving score may be shared in a social network and/or in a game with other drivers or one or more computer-generated opponents competing for the safest driving score. By way of another example, earning a safe driving score may reward a driver with lower auto insurance rates. In the alternative, an unsafe driving score may be a disincentive for aggressive drivers that may incur auto insurance penalty fees. Further, in one embodiment, leveraging the information gathered, the system 100 may help monitor driver and vehicle differentiations (e.g., person, route, emotional or waking state of the driver, etc.) and adjust vehicle and driving settings accordingly. Further, the system 100 may present offers to drivers based on vehicle location and/or condition.

To implement the above, the system 100 may collect, in real time, a plurality of contextual parameters associated with a user operating one or more vehicles. By way of example, one or more contextual parameters may include the identity of the driver, the driver's driving history and credit score, vehicle information, geographic location, typical routes travelled or areas covered while driving, weather, local driving laws, and percentage compliance of those laws among the local population. The system 100 may further classify the driving behavior of the user based on the collected contextual parameters, where the classified driving behavior corresponds to operation of the one or more vehicles by the user. The system 100 may then generate a driving profile for the user according to the classification. An automotive support platform 101 within the system 100 may implement the above functionality. The automotive support platform 101 may be linked to a service provider network 109. The service provider network 109 may be connected to a telephony network 111, a wireless network 113, a data network 115, or a combination thereof.

For illustrative purposes, the networks 109-115 may be any suitable wireline and/or wireless network, and be managed by one or more service providers. For example, telephony network 111 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), long term evolution (LTE), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 115 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, or other suitable infrastructure to support control and signaling functions.

According to one embodiment, one or more of networks 109-115 may be accessed by telematics device 107 for use in communicating with other elements of the system 100. The telematics device 107 may integrate telecommunications and information processing for use in vehicles and the operation of vehicles. Additionally, telematics device 107 may include, but is not limited to, Global Positioning System (GPS) technology integrated with computers and mobile device communications technology in automotive navigation systems; interface to on-board diagnostic standard digital communication port in automobiles that provide real-time data; integrated hands-free cell phones, wireless safety communications and automatic driving assistance systems. Accordingly, telematics device 107 may acquire and relay information regarding the operation of one or more vehicles (e.g., vehicles operated by a user) to one or more elements of the system 100, such as the automotive support platform 101. Such information acquired by the telematics device 107 may include, for example, vehicle speed, breaking characteristics, tachometer readings, odometer readings, travel direction, engine information (e.g., oil level, whether maintenance is required, temperature reading, etc.), and other general information regarding the operation of a vehicle, such as levels of fluids (e.g., coolant, fuel, wiper fluid, etc.). Although only one telematics device 107 is illustrated in FIG. 1, the system 100 may include more than one telematics device 107, such as at least one telematics device 107 for each vehicle associated with the system 100.

The system 100 may also include one or more user devices 105a-105n (collectively referred to as UDs 105) that may communicate with other elements within the system 100 to effectuate one or more functions of the automotive support platform 101. The UDs 105 may include any customer premise equipment (CPE) capable of sending and/or receiving information over one or more of networks 109-115. For instance, the UDs 105 may constitute any smart phone, or any other suitable mobile device, such as a personal digital assistant (PDA), pocket personal computer, tablet, personal computer, customized hardware, etc. In one embodiment, UDs 105 may include and/or interface with brain-computer interface (BCI) chips, galvanic skin response (GSR) sensors, muscle electromyography (EMG) sensors, heartbeat electrocardiography (ECG or EKG) sensors and other biosensor sensors to determine waking state and relative emotion of a user associated with the UDs 105. As illustrated in FIG. 1, the UDs 105 may be connected to or in communication with the telematics device 107 for communicating information regarding the operation of one or more vehicles, such as vehicles operated by a user that is also associated with one or more of the UDs 105.

The UDs 105 may execute one or more applications 119a-119n (collectively referred to as applications 119). The applications 119 may be any type of application that is executable at the UDs 105. By way of example, applications 119 may include one or more media player applications, social networking applications, calendar applications, content provisioning applications, location-based service applications, navigation applications, and the like. In one embodiment, one of the applications 119 at the UDs 105 may provide or act as an interface with respect to the automotive support platform 101 and the telematics device 107. By way of example, such an application may act as a client for automotive support platform 101 and perform one or more functions associated with the functions of the automotive support platform 101 at the UD 105 by interacting with the automotive support platform 101 over communication networks 109-115 and/or communicating with the telematics device 107.

As used herein, a vehicle is any automobile, motorcycle, truck, trailer, tractor, bus, armored fighting vehicle, train, aircraft, watercraft, spacecraft, or mobile machine that transports passengers or cargo and may be associated with telematics device 107. A driver refers to a person operating the vehicle associated with telematics device 107. The term vendor is used to refer to an entity that offers goods and/or services. The term servicer refers to a business entity partnering to offer the services associated with the automotive support platform 101 (e.g., vehicle manufacturer).

According to one embodiment, the automotive support platform 101 is capable of determining a driving profile, which may include a driving score. The automotive support platform 101 may update the driving profile and/or driving score in real time or near real time. As shown, the automotive support platform 101 may include (or have access to through the service provider network 109) a driver information database 103 and an incentives database 117. The driver information database 103 may, for instance, be utilized to access or store driver information, such as driver identifiers, passwords, device information associated with drivers, payment resource information associated with drivers, such as credit cards, debit cards, banks, loyalty points, etc. The incentives database 117 may be utilized to store information regarding servicers, offers, merchant-specific loyalty programs, and servicers' parameters and requirements for various offers, vendors, etc. The information stored within the incentives database 117 may also be categorized or otherwise indexed with respect to geographic regions such that, for example, specific offers may be provided with respect to specific geographic regions. The information within the incentives database 117 may be populated by one or more vendors and/or servicers interfacing with the automotive support platform 101.

The automotive support platform 101 is capable of outputting driving profiles determined by risk analysis from multiple facets of the driver's life, which consolidate the context of driving behavior as a collation of driving habits alongside lifestyle behaviors, such as credit score maintenance. After applying the risk analysis, the automotive support platform 101 then combines linear regression and an artificial neural network model capable of multiple inputs to generate a real time and/or near real time scoring service and predictive scorecard. In one embodiment, the artificial neural network represents a model trained by the use of a backpropagation algorithm and may be composed of an input layer containing several input nodes (e.g., 11), and an output layer connected to an output node. Each input node receives one or more input values, each coming via, for example, a UD 105, the telematics devices 107, the driver information database 103, the incentives database 117, and/or from one or more of the networks 109-115, and generates an output value, such as one output value. That is, the automotive support platform 101 is capable of identifying a correct output after receiving a series of inputs. For example, an artificial neural network may be taught to correctly identify the name “cat’ after receiving several inputs of pictures different kinds of cats. As applied to the automotive support platform 101, the artificial neural network may receive a critical mass of input data, wherein the input data may be ascribed to a certain type of driver (e.g., “safe”, “average”, or “dangerous” driver). Therefore, system 100 associates one more factors in the contextual parameters including credit score and the driving behavior or a combination thereof, and analyzes the contextual parameters based on statistical techniques, machine learning, artificial intelligence, traditional driving guidelines, or a combination thereof.

The automotive support platform 101 may automatically recognize patterns in data not obvious to the expert eye to determine one or more behavior incentives or offers to extend to the driver. The automotive support platform 101 may generate a predictive model for predicting behavior propensity and inducement-behavior experimental choices corresponding to one or more of the driving profiles. The automotive support platform 101 may continually update a user's driving profile and/or driving score based on the incoming data from the driving behavior. For example, if the automotive support platform 101 initially gave a driver a good driving score based on the first five minutes of a trip, but then the driver exceeds the speed limit during the next five minutes of the trip, the automotive support platform 101 may update the initial driving score and change the driving score to reflect the riskier driving with a lower driving score. In one embodiment, the automotive support platform 101 may determine the accuracy of the predictive model based on incoming data, and modify the driving score based on the predictive model's accuracy.

In one embodiment, a newly enrolled driver may connect UD 105a into the telematics device 107. This connection may be wired or wireless, depending on the UD 105a and telematics device 107 capabilities. UD 105a may begin aggregating vehicle data and establish a connection with the automotive support platform 101. The automotive support platform 101 then may return feedback and incentives to the UD 105a that may be relevant to the driver based on the newly received data. In one embodiment, the driver may see this feedback on the UD 105a via one or more of the applications 119a. That is, the applications 119 may report and store real-time and post-drive analysis, and near real-time scoring. In one embodiment, applications 119 may allow a user to set the feedback frequency (e.g., score reporting, etc.) for the above features. Additionally, applications 119 may allow users to share (manually or automatically) driving scores in social networks and associated games. By way of example, one or more applications 119 may be programmed by services and/or vendors to use driving scores to determine and/or offer incentives and/or disincentives. Applications 119 may also provide visual and/or spoken feedback so that a user may decide whether she prefers the application to communicate visually, through speech, or a combination thereof.

According to one embodiment, applications 119 may offer on-boarding support, such as aiding a driver to create a new driving profile with automotive support platform 101. Additional forms of on-boarding support may include registering multiple or new vehicles and/or UDs 105 to an existing driving profile, updating the driver profile information, system settings, and technical support. In one embodiment, the applications 119 may provide technical support, which may consist of a searchable help menu, digital owner's manual, or a live contact through a phone call, short messaging service (SMS), email, or social media.

By use of one or more different applications 119 that may all interface with the automotive support platform 101, different vehicle manufacturers may re-brand a core application and/or user interfaces with respect to specific information associated with the vehicle manufacturers and/or vehicle manufacturers' vehicles. For example, Acme Car Company may re-brand applications 119 to reflect Acme's logo, color scheme, and business information such as service locations, dealer locations, customer support contact information, etc. The ability to re-brand applications 119 and, therefore, the user interfaces associated with the platform-based architecture of the automotive support platform 101 allows the automotive services industry to offer such services to consumers outside of the population of people who can afford high-end vehicles while tailoring such services to specific servicers.

In one embodiment, by interfacing with the automotive support platform 101, applications 119 may support in-vehicle payments by leveraging smart phone users' profile identities. That is, the automotive support platform 101 may detect a driver is operating a vehicle and collect, in response to the detection of the driver operating the vehicle, a driver profile from a UD 105a of the driver, wherein the profile data includes payment information associated with the driver profile for completion of a transaction. Further, such transactions may be based in information leveraged by the automotive support platform 101, such as location of the vehicle and one or more conditions of the vehicle. By way of example, the telematics device 107 may indicate that a vehicle requires more fuel and the automotive support platform 101 may provide transactions for the user to purchase fuel at nearby fueling stations.

In one embodiment, the automotive support platform 101 may automatically switch to various settings, such as turning off SMS tones or disabling the UD 105a screen when the vehicle is in motion, of one or more applications 119 based on data received regarding the current physical status of the vehicle. For example, the automotive support platform 101 through information from the telematics device 107 may automatically recognize that a vehicle is currently in drive mode, and in response, turn on safety features and configure messages for answering phone calls or SMS during driving. In one embodiment, the automotive support platform 101 may make further adjustments to one or more applications 119 based on determinations such as road, vehicle, and driver differentiation.

In one embodiment, the automotive support platform 101 may discern the waking and emotional state of the driver as well as anomalies in the route traveled (as compared with regular routes traveled by the driver and observed by telematics device 107, UDs 105, and automotive support platform 101). When the automotive support platform 101 detects that the driver has chosen an abnormal route, this event may cause the automotive support platform 101 to note there might be a problem with the vehicle or the driver's usual level of attentiveness may be compromised. The automotive support platform 101 may monitor the driver's wake or emotional state via a brain-computer interface (BCI) chip, galvanic skin response (GSR) sensors, muscle electromyography (EMG) sensors, heartbeat electrocardiography (ECG or EKG) sensors and other biosensor inputs within UDs 105 or telematics device 107. Automotive support platform 101 may detect, by one or more sensors, associated with a UD 105 operated by the user, emotional or waking state of the user, and associate the detected state of the user with the driving behavior, the driving profile, or a combination thereof.

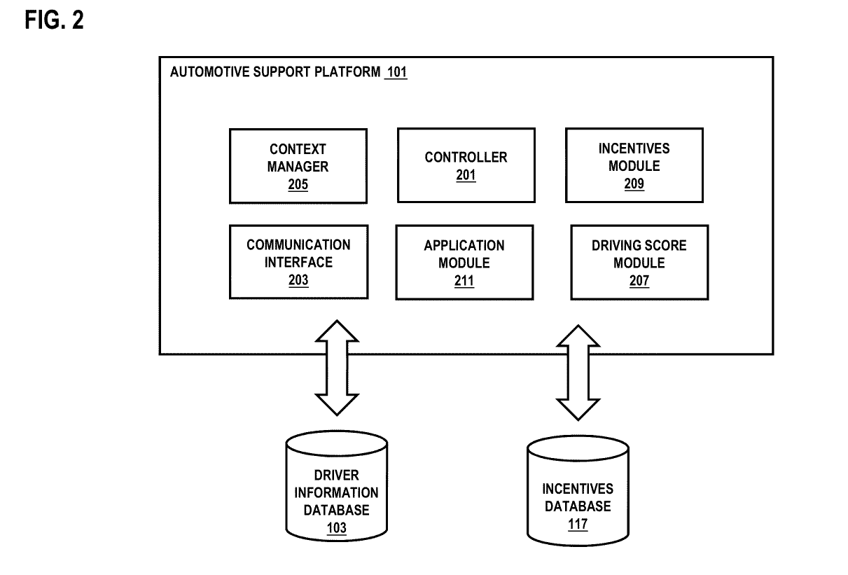

FIG. 2 is a diagram of an automotive support platform 101 used in the system of FIG. 1, according to an exemplary embodiment. Although illustrated as a separate element with respect to a service provider network 109 within the system 100, the automotive support platform 101 may alternatively be embodied in, for example, one or more applications 119 executed at the UDs 105 or connected to another one of the networks 111-115. In one embodiment, the automotive support platform 101 contains a controller 201, a communication interface 203, a context manager 205, a driving score module 207, an incentives module 209, and an application module 211. The automotive support platform 101 may communicate with the driver information database 103 to retrieve a driver's user profile, archived history, and the associated metadata for the user profile. The automotive support platform 101 may also communicate with the incentives database 117 to retrieve incentives, incentive parameters, and offers from vendors.

The controller 201 performs control logic functions and facilitates coordination among the other components of automotive support platform 101. In one embodiment, the communication interface 203 receives data from UDs 105 and telematics device 107 via networks 109-115 and provides this data throughout the automotive support platform 101. After the communication interface 203 receives data from UDs 105 and/or telematics device 107, it may transfer the data to context manager 205 to prepare (e.g., formats, organizes, etc.) the data for submission to the driving score module 207 as contextual driver information. As an example, contextual driver information may include driver profile, credit score, vehicle information (as provided from the metadata received from telematics device 107), date, location, weather, current driving behavior, etc.

The driving score module 207 creates a risk profile based on the contextual driver information received from the context manager 205 via the communication interface 203. The driving score module 207 may eventually determine a driving score based on the risk profile. The driving score module 207 may analyze the contextual driving information according to statistics, driving guidelines, and its neural network to determine the driving score and transmit this score to the incentives module 209.

The incentives module 209 may search the incentives database 117 to determine which incentives are applicable to the driver based on the current driving score and contextual information. The incentives module 209 then transmits the applicable offers and the driving score module 207 transmits the driving score to applications module 211.

The applications module 211 may format, package, and transmit the driving score and incentive offers to the applications 119 via communication interface 203 and networks 109-115. The application module 211 communicates and syncs the data sent to the applications 119, including on-boarding support, driving scores, driver preferences, drive modes, message and SMS settings, associated social networks and games, and road, driver, and vehicle differentiation.

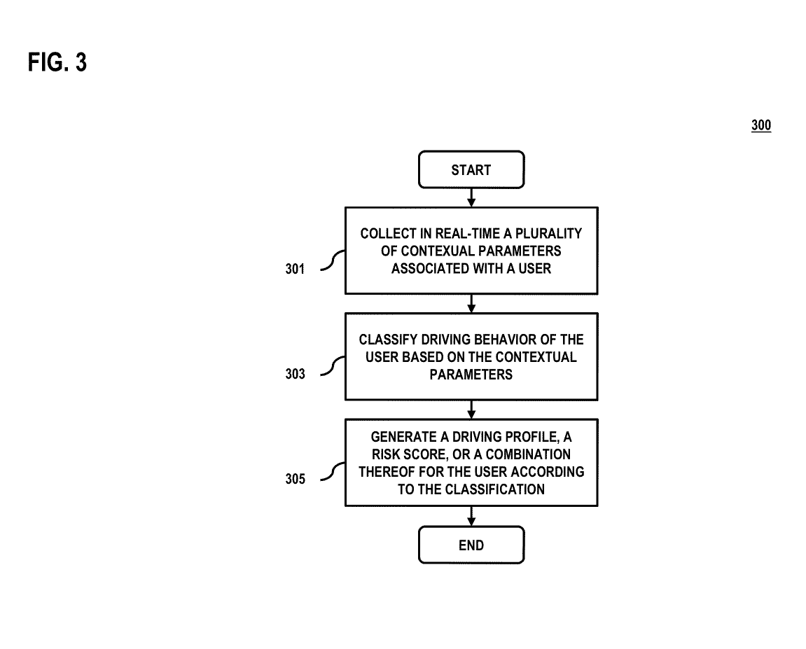

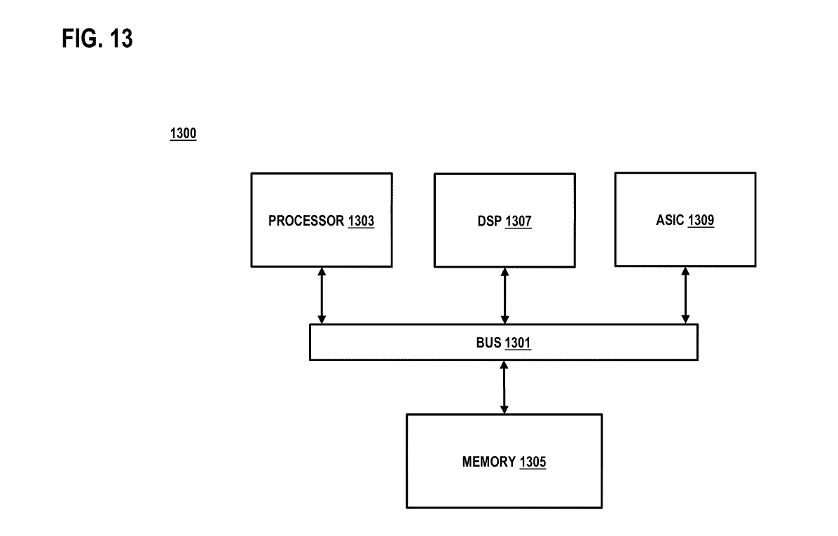

FIG. 3 is a flowchart of a process 300 for determining driver information based on multiple variables in order to determine a driving profile, according to one embodiment. In one embodiment, the automotive support platform 101 performs the process 300 and is implemented in, for instance, a chip set including a processor and a memory as shown in FIG. 13. Although FIG. 3 illustrates steps 301 through 305 in a particular order, the order and number of steps are merely for explanation, and one or more steps may be performed in a different order or removed. In step 301, the automotive support platform 101 may collect, in real-time, a plurality of contextual parameters associated with a user. According to one embodiment, the automotive support platform 101 may collect the contextual parameters from the UDs 105, telematics device 107, or a combination thereof. By way of example, the automotive support platform 101 may collect in real time if the UD 105a is connected by way of a 4G or broad range Wi-Fi network, or in near real time if the UD 105a is connected by way of a 3G network. Contextual parameters may include data such as the identity of the driver, driver's driving history, credit score, vehicle information, geographic location, weather, local driving laws, and percentage compliance of those laws among the local population.

In step 303, the automotive support platform 101 may classify the driving behavior of the user based on the contextual parameters, wherein the driving behavior corresponds to the operation of one or more vehicles by the user. The user's operation of the vehicle as determined by telematics device 107 may determine some of the contextual parameters, such as contextual parameters associated with the speed of the vehicle, acceleration of the vehicle, braking of the vehicle, etc. According to one embodiment, the automotive support platform 101 may utilize the location information of the driver to determine what the local driving rules are. The automotive support platform 101 may utilize these driving rules as guidelines by which to measure the quality and safety of the driver's operation of the vehicle based on the contextual parameters. By way of example, the driving behavior may be classified as safe or not safe. The driving behavior may also have finer granularity, such as safe, average, and not safe, and the like.

In step 305, the automotive support platform 101 may generate a driving score for the user according to the classification. According to one embodiment, the automotive support platform 101 may dispatch the recently received data to the driving score module 207, and in real time, the driving score module 207 may determine the current driving score and/or classify the current driving quality according certain ranges (e.g., a driving profile). As mentioned, the driving profile may take into account the driver's compliance with local traffic rules as well as other factors that may affect one's driving that may not be detected by a telematics device 107, such as the driver's credit score, emotional or waking state, weather, traffic, and route anomaly. In one embodiment, the driving behavior may be based on a score, such as 90 out of 100, which may indicate that the driver drove safely 90% of a period of time, such as during the length of a trip or while the vehicle was moving. However, the automotive support platform 101 may provide driving score of the user according to any format or style. The automotive support platform 101 may then leverage the driving score with respect to other information, such as incentives and/or offers with respect to the user.

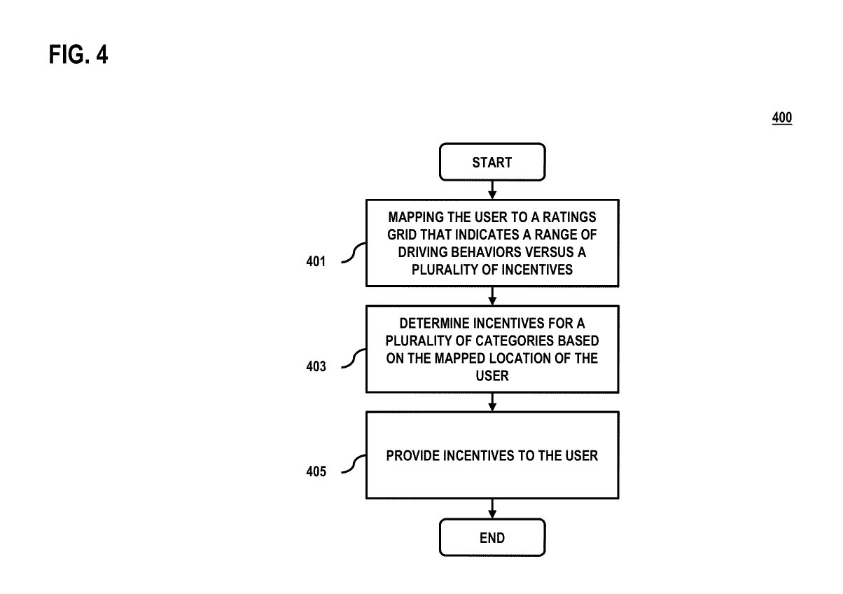

FIG. 4 is a flowchart of a process 400 for categorizing driving scores onto a ratings grid, according to one embodiment. In one embodiment, the automotive support platform 101 performs the process 400 and is implemented in, for instance, a chip set including a processor and a memory as shown in FIG. 13. Although FIG. 4 illustrates steps 401 through 405 in a particular order, the order and number of steps is merely for explanation, and one or more steps may be performed in a different order or removed. In step 401, the automotive support platform 101 may map the user to a ratings grid that indicates a range of driving behaviors versus a plurality of categories of incentive inducements. According to one embodiment, the automotive support platform 101 may create a driving score grid in addition to determining driving scores for drivers. For example, automotive support platform 101 receives data that Driver A only comes to complete stops at stop signs twenty-seven percent of the time. This data may lower Driver A's driving score. Further, automotive support platform 101 may receive data indicating that drivers in Driver A's region come to complete stops seventy-nine percent of the time. According to one embodiment, this lowering of Driver A's score may be sufficient to change Driver A's classification from an acceptable driver to a potentially risky driver. Such a change in classification may affect Driver A's location on the ratings grid, which may, in turn, require her to pay penalty fees by her automobile insurance company or no longer receive incentives for good driving.

In step 403, the automotive support platform 101 determines one or more incentive inducements for one of the plurality of categories based on the mapped location of the user. According to one embodiment, the automotive support platform 101 receives real time data indicating that Driver B has not exceeded any speed limits for six consecutive months. The automotive support platform 101 may search the incentives database 117 for incentives which may be available to Driver B based on, by way of example, her driving score, geographic location, make and model of her vehicle, favorite vendors, and credit score. As discussed above, the incentives database 117 stores the latest offers as provided by vendors including the minimum qualifying score for eligibility of incentives and rewards.

In step 405, the automotive support platform 101 provides one or more incentive inducements to the user; wherein the incentive inducements, plurality of categories, or a combination thereof is associated with one or more applications relating to social networking, insurance, gamification, or a combination thereof. Continuing with the previous example, the automotive support platform 101 may reward Driver B's high driving score and bonus points for the extended period in excellent driving. According to one embodiment, the automotive support platform 101 and incentives database 117 may determine Driver B's high score may qualify her for a discount in her automotive and/or life insurance rate for that month. According to one embodiment, a driver may be rewarded for a good driving score with a discount for her health insurance company. According to another embodiment, Driver B may share this high driving score in a social network via application 119a. Gamification is the use of game thinking and mechanics in a non-game context in order to engage drivers to driver more safely. According to another embodiment, Driver B's score in a game with her circle of friends, computer generated opponents, or a combination thereof, may be automatically updated to reflect her recent driving achievement or incentive inducement reward.

In addition to behavioral incentives tied to driving score, the incentives database 117 may also determine a driver may be eligible for offers and discounts based on location, vehicle conditions, or consumer loyalty programs. According to one embodiment, if the automotive support platform 101 receives data from the telematics device 107 that the vehicle is in need of an oil change, the automotive support platform 101 through an application 119a may highlight local mechanics, garages, and/or car dealerships to the driver. Additionally, the automotive support platform 101 may offer special promotions from local vendors who are launching a new product. When a driver is within a certain radius of the offer location, the automotive support platform 101 may present the offer to the driver via applications 105. In another example, the driver's profile may indicate that the driver is a member of a vendor's loyalty program. In such a case, the automotive support platform 101 my notify the driver whenever she is within a certain radius of the vendor, and also of current offers associated with the vendor and/or the vendor's loyalty program members regardless of the driver's location.

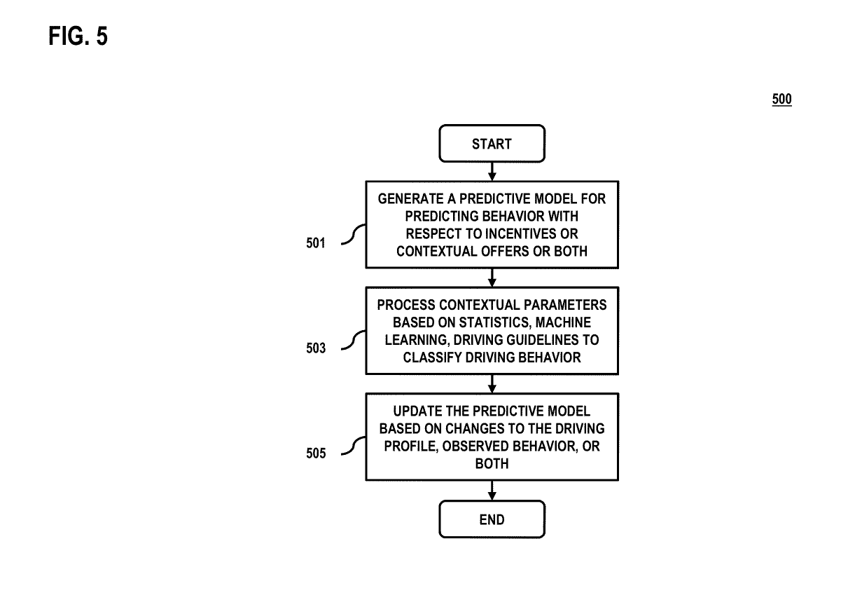

FIG. 5 is a flowchart of a process 500 for utilizing a predictive model to determine incentives based on a driver's driving score, driving profile, or a combination thereof, according to one embodiment. Although FIG. 5 illustrates steps 501 through 505 in a particular order, the order and number of steps is merely for explanation, and one or more steps may be performed in a different order or removed. In one embodiment, the automotive support platform 101 performs the process 500 and is implemented in, for instance, a chip set including a processor and a memory as shown in FIG. 13. In step 501, the automotive support platform 101 may generate a predictive model for predicting behavior with respect to one or more incentive inducements, one or more contextual offers, or a combination thereof. In addition to determining which offers and incentives are available to a user according to a vendor's parameters, the automotive support platform 101 may also seek to determine which offers may be particularly appealing to drivers. By way of example, the automotive support platform 101 may keep a log of the drivers' former responses to various offers as one of the ways in which the automotive support platform 101 may seek to predict which offers may be appealing to drivers. According to one embodiment, in each situation where offers and incentives are presented to a driver, the driver may have the option to redeem, save, ignore, or reject the offer. Additionally, the applications 119 may give the driver the option of rating, liking, or disliking any given offer so that the automotive support platform 101 may gather additional data on the driver's preferences with regard to offers and incentives. The automotive support platform 101 may store the driver's responses to various offers and incentives in the driver information database 103, UDs 105, and incentives database 117.

In step 503, the automotive support platform 101 may process the contextual parameters based on statistical techniques, machine learning, artificial intelligence, traditional driving guidelines, or a combination thereof to classify the driving behavior, where the plurality of driving parameters include credit score. According to one embodiment, controller 201 and driving score module 207 may utilize factors such as driving history, demographics data, driving mileage, and credit history along with regression models, traditional guidelines, etc. to predict one or more offers for incentives that may be relevant to the driver. According to one embodiment, the driving score module 207 may organize, format, and assign the raw data to the associated driver from the driver information database 103. In the case that the driver is not located in the driver information database 103, a new driver profile is created in the driver information database 103. According to one embodiment, the driving score module 207 may create a preliminary driving profile from a collection of the driver's credit score, and current and past driving behavior. According to one embodiment, a regression model, neural network, and traditional guidelines are used to determine the driving score.

In step 505, the automotive support platform 101 may update the predictive model based on changes to the driving profile, observed behavioral propensity, or a combination thereof. The automotive support platform 101 may continually refine its predictions regarding which offers and incentives may be most valued by drivers by performing analytical analysis on each driver's responses. Additionally, the automotive support platform 101 may further refine the predictive model by observing what offers and incentives similar drivers find appealing. The automotive support platform 101 may identify similar drivers with such factors such as location, make and model of vehicle, frequency of trips, length of trips, time of trips, and similar responses and ratings of the same offers and incentives.

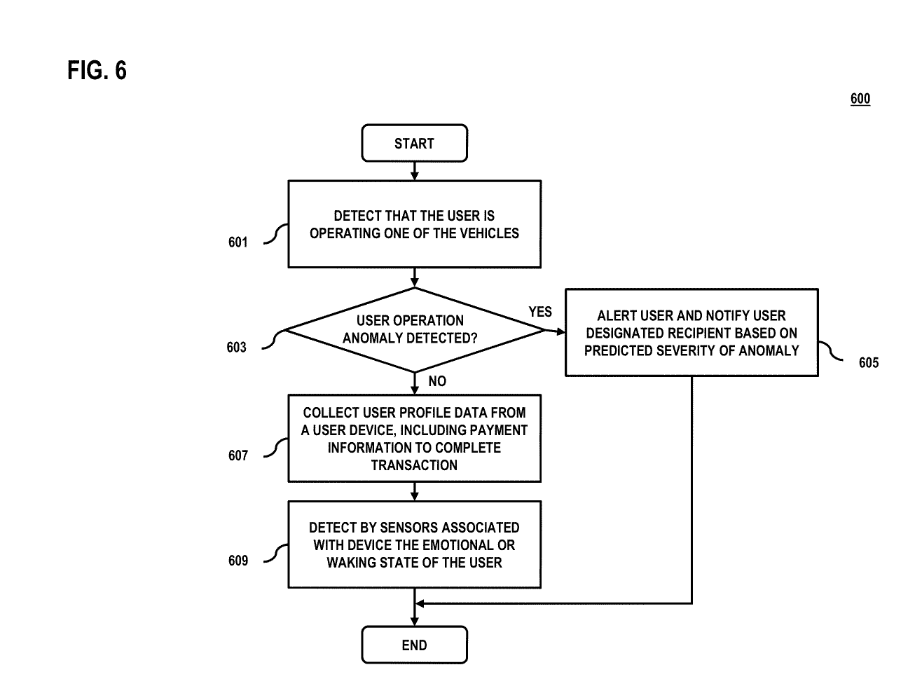

FIG. 6 is a flowchart of a process for enabling an in-vehicle user identification, associated in-vehicle authenticated payment system and identifying the waking and/or emotional state of the driver, according to one embodiment. Although FIG. 6 illustrates steps 601 through 609 in a particular order, the order and number of steps is merely for explanation, and one or more steps may be performed in a different order or removed. In one embodiment, the automotive support platform 101 performs the process 600 and is implemented in, for instance, a chip set including a processor and a memory as shown in FIG. 13. In step 601, the automotive support platform 101 may detect that the user is operating one of the vehicles associated with telematics device 107. According to one embodiment, telematics device 107 transmits to the UD 105a and application 119a that the car has started and is currently in use. According to another embodiment, telematics device 107 may transmit this data directly to automotive support platform 101 wirelessly over one or more of the networks 109-115.

In step 603, the automotive support platform 101 may determine, in response to the route travelled by the vehicle, that a route anomaly has been detected, dispatch, in response to the detection of an anomaly, an alert to the user device of the user, and notify a third party regarding the anomaly event detected. A predictive score may be associated with the anomaly detection that identifies the severity of the event. If an anomaly is detected, the process proceeds to step 605. If an anomaly is not detected, the process proceeds to step 607.

In step 605, depending on the predicted severity, a series of events may be dispatched starting with a simple user alert requesting counter-authentication, to activation of alarm and notification of event to a pre-designated third party. Such anomaly detection and alerts may be useful in, for example, situations involving teenage drivers restricted to certain routes and vehicle theft notifications.

In step 607, the automotive support platform 101 may detect that the user is operating one of the vehicles, and collect, in response to the detection of the user operating the one vehicle, user profile data from the UD 105a of the user, wherein the profile data includes payment information associated with the user profile for completion of a transaction. The payment information may be used by the automotive support platform 101 to effectuate one or more transactions performed by the user based on one or more offers provided to the user through one or more applications 119 as a result of leveraging information regarding the driving experience. According to one embodiment, the automotive support platform 101 may determine the driver profile from the user associated with the UD 105a, login information from application 119a, telematics device 107, or a combination thereof. After the automotive support platform 101 has determined the driver profile associated with the driver, the automotive support platform 101 may extract the associated financial funding institution associated with the driver profile. According to another embodiment, the UD 105a and application 119a may transmit the user's associated financial funding institution to the automotive support platform 101 in the initial transmittal with the driver profile.

In step 609, the automotive support platform 101 may detect, by one or more sensors associated with the UD 105a operated by the user, emotional or waking state of the user and associate the detected state of the user with the driving behavior, the driving profile, or a combination. According to one embodiment, system 100 may include a number of biosensors that may transmit data relevant to the emotion or waking state of the driver. Examples of such biosensors include: BCI chip based interface and/or GSR, EMG, ECG, EKG, and others. These sensors may have wireless capabilities and may interface with the telematics device 107, UD 105, automotive support platform 101, or a combination thereof. By way of example, if a driver's ECG reports a lowering of a driver's heart rate, the controller 201 may transmit a spoken message to the driver via application 119a to alert the driver that she may be too tired to drive safely.

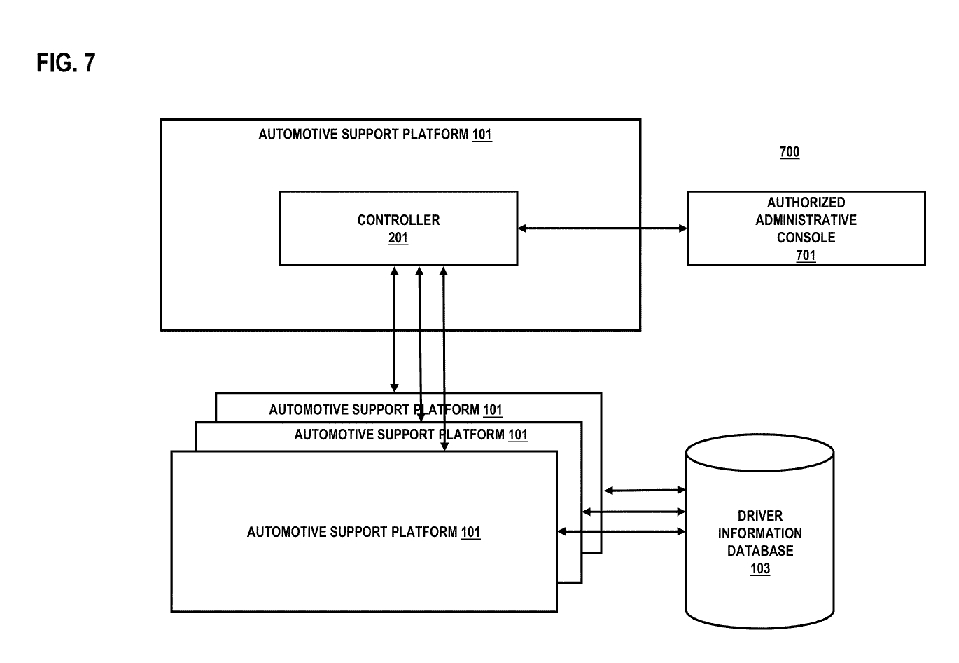

FIG. 7 is a diagram of an automotive support platform 101 utilized over a cloud network, according to one embodiment. The authorized administrative console 701 generates an instance of the automotive support platform 101 on demand associated with a servicer. Each instance of the automotive support platform 101 gives the servicer requesting access through to the automotive support platform 101 the ability to manage the services provided.

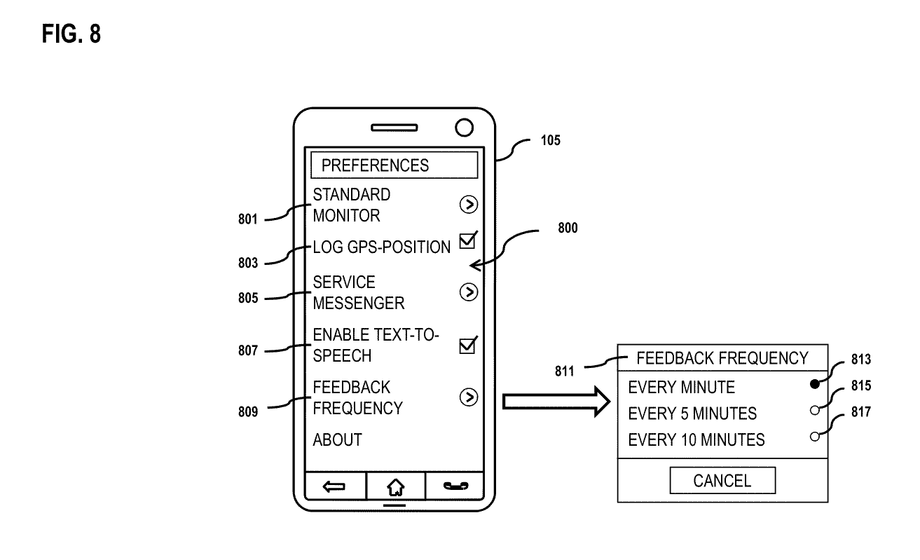

FIG. 8 is a diagram of a user interface 800 of a UD 105 utilized in the process of FIGS. 3-6, according to one embodiment. FIG. 8 illustrates an example of settings available to the driver with application 119a. In one scenario, a driver is able to configure a number of settings according to her preferences. The Standard Monitor 801 option allows the driver to select various display resolutions for the UD 105a screen. The Log GPS-Position 803 option allows the driver to determine whether the automotive support platform 101 may take into account her GPS position in determining her driving score. The Service Messenger 805 option may allow the driver to configure messages for answering calls or SMS during driving. The Enable Text-To-Speech 807 option may be toggled to cause UD 105a to speak what is currently displayed on the screen. The Feedback Frequency 809 option may allow the driver to set the driving score feed. Upon selecting the Feedback Frequency 809 option, a drop-down menu 811 may appear that provides options of, for example, every minute 813, every five minutes 815, every ten minutes 817, etc.

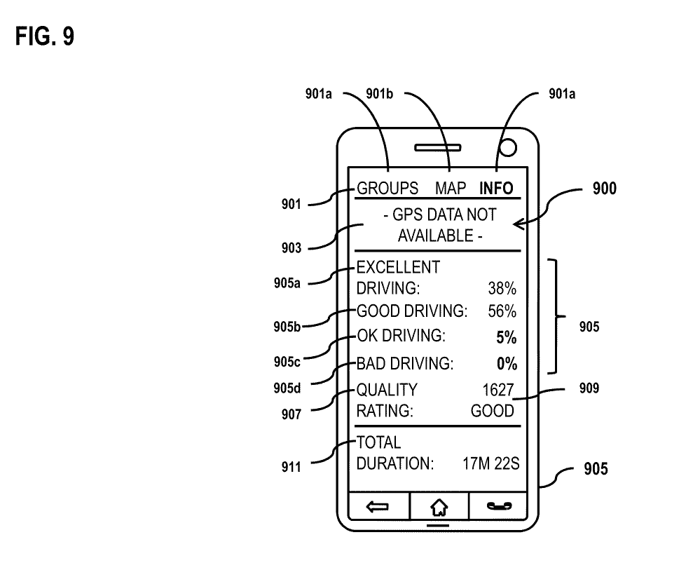

FIG. 9 is a diagram of a user interface 900 of a UD 105 utilized in the processes of FIGS. 3-6, according to one embodiment. FIG. 9 illustrates an example of a report and breakdown of a driving score. In one embodiment, the user interface 900 includes a navigation pane 901 with menu options 901a-901c across the top of the screen. Beneath the navigation pane 901, the user interface 900 may include GPS data 903; or, if the data is not available, may indicate that the GPS is not available. Beneath the GPS data 903, the user interface 900 may include percentages of time during the trip the driver engaged in different categories of driving quality 905, such as excellent driving 905a, good driving 905b, OK driving 905c, and bad driving 905d. Alternatively, categories of driving quality 905 may be reported in terms of minutes for each category. In one embodiment, the user interface 900 may include particular factors that contributed to the determination of a driving quality. For example, if the driver selects on Excellent Driving 905a, the user interface 900 may include a list that specifies reasons such as: stopped at five red lights, stayed within the speed limit, signaled before changing lanes, etc. Beneath the categories of driving quality 905, a Quality Rating 907 reports the overall score 909 of the driving in terms of points and the corresponding category of the overall score 909 (e.g., GOOD). The user interface 900 may also include the Total Duration 911 of the entire trip.

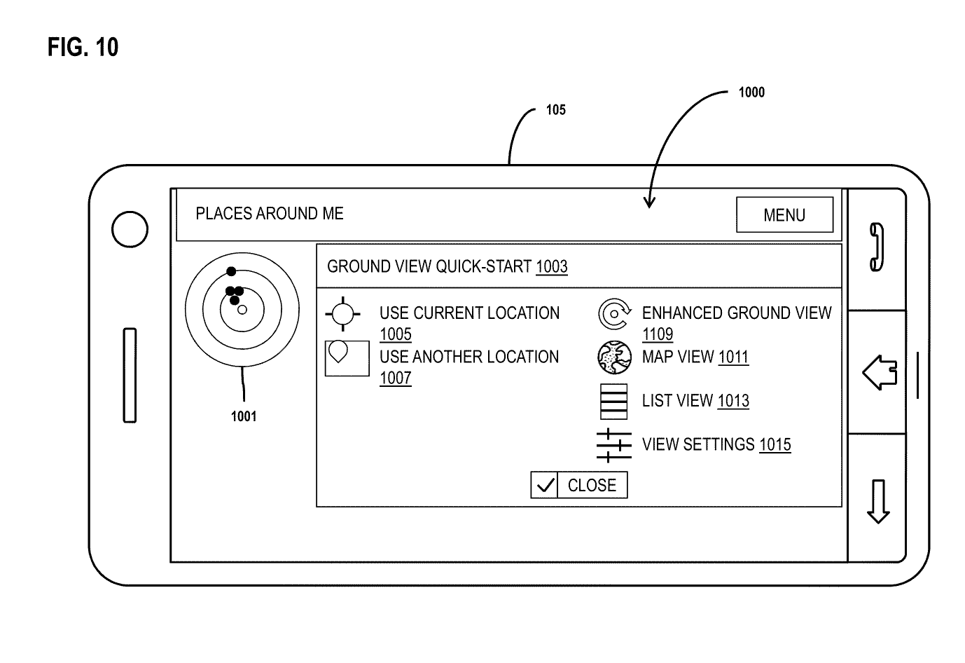

FIG. 10 is a diagram of a user interface 1000 of a UD 105 utilized in the processes of FIGS. 3-6, according to one embodiment. FIG. 10 illustrates an example of the ability to dispatch offers to mobile users. In one scenario, vendors may feature contextual awards and incorporate the simple overlay of contextual offers in a circular 10-100 meter grid 1001 around the UD 105, where the center of the grid 1001 represents the location of the UD 105. For example, a quarter tank of gas event can be set to trigger activation of appropriate gas discounts and vocalization of the top offer as a notification to the driver. In another example, sending gifts to friends or picking up gifts are additional social features that are part of contextual offers and awards. The user interface 1000 may include a Ground View Quick-Start 1003 menu that allows a driver to select Use Current Location 1005 to set the contextual offers to reflect her current location. The driver may also select the Use Another Location 1007 to select another location. In one embodiment, there are three views from which the driver may view a graphical underlay of contextual offers including: Enhanced Ground View 1009, Map View 1011, and List View 1013. The Enhanced Ground View 1009 may display a satellite image of the surrounding area. The Map View 1011 may display a graphical map of the surrounding area. The List View 1013 may display the surrounding contextual offers in the form of a list. The driver may edit any of these options by clicking on View Settings 1015. For example, a driver may select the List View 1013 to display the contextual offers by distance, category, expiration of deals, etc. By selecting the View Settings 1015, the driver may set preferences with respect to maps, like the default map radius and the level of detail in the maps.

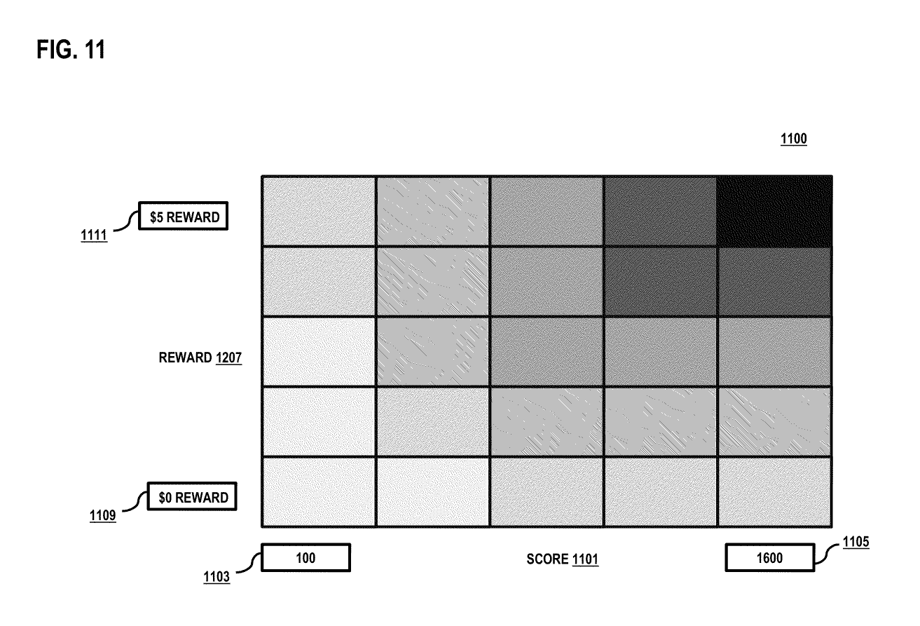

FIG. 11 is a diagram of an incentives-determinative ratings gird utilized in the processes of FIGS. 5-6, according to one embodiment. FIG. 11 illustrates a system 1100 that is an example of a ratings grid that the automotive support platform 101 may utilize to categorize drivers and organize incentives. The variable along the x-axis is the score 1101, where a score near the 100 points range 1103 may be categorized as a “bad driver” and a score near the 1600 points range 1105 may be considered an “excellent driver.” The variable along the y-axis is the amount of the reward 1107. In one scenario, a $0 reward 1109 (e.g., no reward) is given for a bad driving score 1103, while a $5 reward 1111 is given for an excellent driving score 11005. In another scenario, servicers may choose to discourage low driving scores by charging penalty fees (rather than providing no rewards) for bad driving.

The processes described herein for providing for determining and scoring driving quality in real-time while supporting various in-vehicle services and leveraging information associated with and related to the driving experience may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

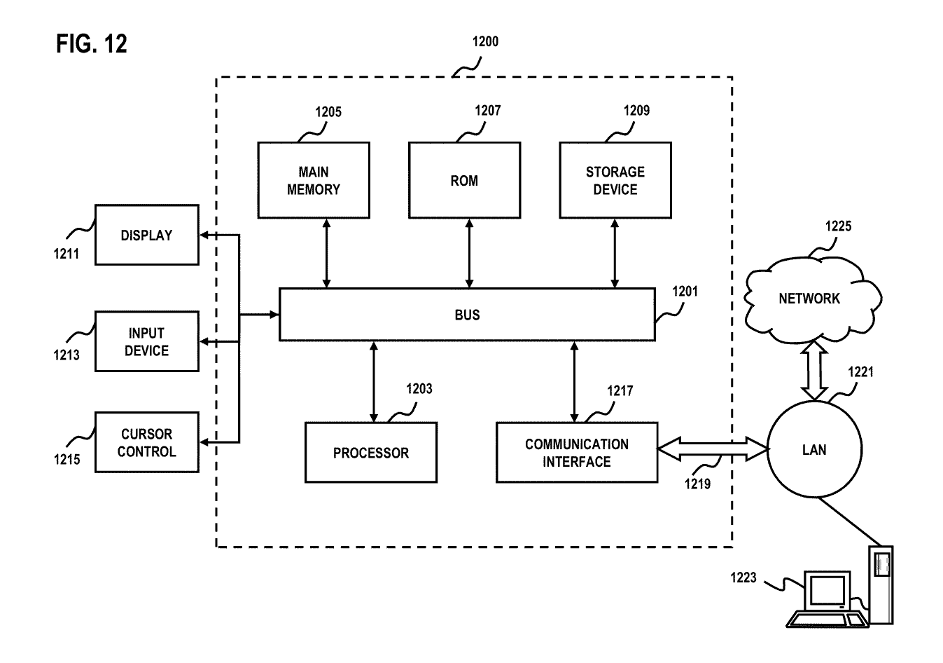

FIG. 12 is a diagram of a computer system that can be used to implement various embodiments. The computer system 1200 includes a bus 1201 or other communication mechanism for communicating information and a processor 1203 coupled to the bus 1201 for processing information. The computer system 1200 also includes main memory 1205, such as a random access memory (RAM) or other dynamic storage device, coupled to the bus 1201 for storing information and instructions to be executed by the processor 1203. Main memory 1205 can also be used for storing temporary variables or other intermediate information during execution of instructions by the processor 1203. The computer system 1200 may further include a read only memory (ROM) 1207 or other static storage device coupled to the bus 1201 for storing static information and instructions for the processor 1203. A storage device 1209, such as a magnetic disk or optical disk, is coupled to the bus 1201 for persistently storing information and instructions.

The computer system 1200 may be coupled via the bus 1201 to a display 1211, such as a cathode ray tube (CRT), liquid crystal display, active matrix display, or plasma display, for displaying information to a computer user. An input device 1213, such as a keyboard including alphanumeric and other keys, is coupled to the bus 1201 for communicating information and command selections to the processor 1203. Another type of user input device is a cursor control 1215, such as a mouse, a trackball, or cursor direction keys, for communicating direction information and command selections to the processor 1203 and for controlling cursor movement on the display 1211.

According to an exemplary embodiment, the processes described herein are performed by the computer system 1200, in response to the processor 1203 executing an arrangement of instructions contained in main memory 1205. Such instructions can be read into main memory 1205 from another computer-readable medium, such as the storage device 1209. Execution of the arrangement of instructions contained in main memory 1205 causes the processor 1203 to perform the process steps described herein. One or more processors in a multi-processing arrangement may also be employed to execute the instructions contained in main memory 1205. In alternative embodiments, hard-wired circuitry may be used in place of or in combination with software instructions to implement exemplary embodiments. Thus, exemplary embodiments are not limited to any specific combination of hardware circuitry and software.

The computer system 1200 also includes a communication interface 1217 coupled to bus 1201. The communication interface 1217 provides a two-way data communication coupling to a network link 1219 connected to a local network 1221. For example, the communication interface 1217 may be a digital subscriber line (DSL) card or modem, an integrated services digital network (ISDN) card, a cable modem, a telephone modem, or any other communication interface to provide a data communication connection to a corresponding type of communication line. As another example, communication interface 1217 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1217 sends and receives electrical, electromagnetic, or optical signals that carry digital data streams representing various types of information. Further, the communication interface 1217 can include peripheral interface devices, such as a Universal Serial Bus (USB) interface, a PCMCIA (Personal Computer Memory Card International Association) interface, etc. Although a single communication interface 1217 is depicted in FIG. 12, multiple communication interfaces can also be employed.

The network link 1219 typically provides data communication through one or more networks to other data devices. For example, the network link 1219 may provide a connection through local network 1221 to a host computer 1223, which has connectivity to a network 1225 (e.g. a wide area network (WAN) or the global packet data communication network now commonly referred to as the “Internet”) or to data equipment operated by a service provider. The local network 1221 and the network 1225 both use electrical, electromagnetic, or optical signals to convey information and instructions. The signals through the various networks and the signals on the network link 1219 and through the communication interface 1217, which communicate digital data with the computer system 1200, are exemplary forms of carrier waves bearing the information and instructions.

The computer system 1200 can send messages and receive data, including program code, through the network(s), the network link 1219, and the communication interface 1217. In the Internet example, a server (not shown) might transmit requested code belonging to an application program for implementing an exemplary embodiment through the network 1225, the local network 1221 and the communication interface 1217. The processor 1203 may execute the transmitted code while being received and/or store the code in the storage device 1209, or other non-volatile storage for later execution. In this manner, the computer system 1000 may obtain application code in the form of a carrier wave.

The term “computer-readable medium” as used herein refers to any medium that participates in providing instructions to the processor 1203 for execution. Such a medium may take many forms, including but not limited to non-volatile media, volatile media, and transmission media. Non-volatile media include, for example, optical or magnetic disks, such as the storage device 1209. Volatile media include dynamic memory, such as main memory 1205. Transmission media include coaxial cables, copper wire and fiber optics, including the wires that comprise the bus 1201. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 13 illustrates a chip set 1300 upon which an embodiment of the invention may be implemented. Chip set 1300 is programmed to determine and score driving quality in real-time while supporting various in-vehicle services and leverage information associated with and related to the driving experience as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1300, or a portion thereof, constitutes a means for performing one or more steps of FIGS. 3-6.

In one embodiment, the chip set 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1305 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
collecting, in real-time, a plurality of contextual parameters associated with a user;
classifying driving behavior of the user based on the contextual parameters, wherein the driving behavior corresponds to operation of one or more vehicles by the user; and
generating a driving profile for the user according to the classification.

2. A method of claim 1, further comprising mapping the user to a ratings grid that indicates a range of driving behaviors versus a plurality of categories of incentive inducements.

3. A method of claim 2, further comprising:
determining one or more incentive inducements for one of the plurality of categories based on the mapped location of the user; and
providing one or more incentive inducements to the user,
wherein the incentive inducements, plurality of categories, or a combination thereof is associated with one or more applications relating to social networking, insurance, gamification, or a combination thereof.

4. A method of claim 1, further comprising:
generating a predictive model for predicting behavior with respect to one or more incentive inducements, one or more contextual offers, or a combination thereof; and
updating the predictive model based on changes to the driving profile, observed behavioral propensity, or a combination thereof.

5. A method of claim 1, further comprising:
processing the contextual parameters based on statistical techniques, machine learning, artificial intelligence, traditional driving guidelines, or a combination thereof to classify the driving behavior; and
wherein the plurality of driving parameters include credit score, and the driving behavior.

6. A method of claim 1, wherein the collected further comprising:
detecting that the user is operating one of the vehicles; and
collecting, in response to the detection of the user operating the one vehicle, a user profile data from a user device of the user,
wherein the user profile includes payment information associated with the user profile for completion of a transaction.

7. A method of claim 1, further comprising:
detecting, by one or more sensors associated with the user device operated by the user, emotional or waking state of the user; and
associating the detected state of the user with the driving behavior, the driving profile, or a combination.

8. A method of claim 7, wherein the user device includes a cellular phone.

9. An apparatus comprising:
a processor configured to:
collect, in real-time, a plurality of contextual parameters associated with a user,
classify driving behavior of the user based on the contextual parameters, wherein the driving behavior corresponds to operation of one or more vehicles by the user, and
generate a driving profile for the user according to the classification.

10. An apparatus of claim 9, wherein the processor is further configured to:
further comprising mapping the user to a ratings grid that indicates a range of driving behaviors versus a plurality of categories of incentive inducements,
determine one or more incentive inducements for one of the plurality of categories based on the mapped location of the user, and
provide one or more incentive inducements to the user,
wherein the incentive inducements, plurality of categories, or a combination thereof is associated with one or more applications relating to social networking, insurance, gamification, or a combination thereof.

11. An apparatus of claim 9, wherein the processor is further configured to:
generate a predictive model for predicting behavior with respect to one or more incentive inducements, one or more contextual offers, or a combination thereof, and
update the predictive model based on changes to the driving profile, observed behavioral propensity, or a combination thereof.

12. An apparatus of claim 9, wherein the processor is further configured to:
process the contextual parameters based on statistical techniques, machine learning, artificial intelligence, traditional driving guidelines, or a combination thereof to classify the driving behavior, and
wherein the plurality of driving parameters include credit score, and the driving behavior.

13. An apparatus of claim 9, wherein the processor is further configured to:
detect that the user is operating one of the vehicles, and
collect, in response to the detection of the user operating the one vehicle, a user profile data from a user device of the user,
wherein the user profile includes payment information associated with the user profile for completion of a transaction.

14. An apparatus of claim 9, wherein the processor is further configured to:
detect, by one or more sensors associated with the user device operated by the user, emotional or waking state of the user, and
associate the detected state of the user with the driving behavior, the driving profile, or a combination,
wherein the user device includes a cellular phone.

15. A system comprising:
a telematics device configured to collect, in real-time, a plurality of contextual parameters associated with a user; and
an automotive support platform configured to classify driving behavior of the user based on the contextual parameters, wherein the driving behavior corresponds to operation of one or more vehicles by the user, and generate a driving profile for the user according to the classification.

16. A system of claim 15, wherein the automotive support platform is further caused to:
map the user to a ratings grid that indicates a range of driving behaviors versus a plurality of categories of incentive inducements,
determine one or more incentive inducements for one of the plurality of categories based on the mapped location of the user, and
provide one or more incentive inducements to the user,
wherein the incentive inducements, plurality of categories, or a combination thereof is associated with one or more applications relating to social networking, insurance, gamification, or a combination thereof.

17. A system of claim 15, wherein the automotive support platform is further caused to:
generate a predictive model for predicting behavior with respect to one or more incentive inducements, one or more contextual offers, or a combination thereof, and
update the predictive model based on changes to the driving profile, observed behavioral propensity, or a combination thereof.

18. A system of claim 15, wherein the automotive support platform is further caused to:
process the contextual parameters based on statistical techniques, machine learning, artificial intelligence, traditional driving guidelines, or a combination thereof to classify the driving behavior,
wherein the plurality of driving parameters include credit score, and the driving behavior.

19. A system of claim 15, wherein the automotive support platform is further caused to:
detect that the user is operating one of the vehicles,
dispatch, in response to the detection of an anomaly, an alert to the user device of the user, and
notify a third party regarding the anomaly event detected.

20. A system of claim 15, wherein the automotive support platform is further caused to:
detect that the user is operating one of the vehicles, and
collect, in response to the detection of the user operating the one vehicle, a user profile data from the user device of the user,
wherein the user profile includes payment information associated with the user profile for completion of a transaction.

21. A system of claim 15, wherein the automotive support platform is further caused to:
detect, by one or more sensors associated with the user device operated by the user, emotional or waking state of the user, and
associate the detected state of the user with the driving behavior, the driving profile, or a combination,
wherein the user device includes a cellular phone.
